(19) United States
(12) Patent Application Publication
(10) Pub. No.: US 2004/0235419 A1
(43) Pub. Date: Nov. 25, 2004

(54) Method and system for broadcasting information from a satellite

(76) Inventor: Cyril Michel, Toulouse Cedex (FR)

Correspondence Address: STURM & FIX LLP, 206 SIXTH AVENUE, SUITE 1213, DES MOINES, IA, 50309-4076, US

(21) Appl. No.: 10/796,651

(22) Filed: Mar. 8, 2004

Related U.S. Application Data
(63) Continuation of application No. PCT/FR02/03087, filed on Sep. 11, 2002.

(30) Foreign Application Priority Data
Sep. 14, 2001 (FR) 0111921

(51) Int. Cl. H04B 7/185; H04Q 7/20

(52) U.S. Cl. 455/12.1; 455/427; 455/429

(57) ABSTRACT

The invention concerns a method for reducing mutual interference of a digital data transmission or broadcast from a satellite to terrestrial receivers and terrestrial network links using sub-bands each of specific and narrow frequency, belonging to an extended band, the sub-bands being assigned to different terrestrial zones wherein the links are provided. Therefor, the information from the satellite is converted in the form of digital symbols and the digital symbols are distributed over several carriers belonging to a group of carriers distributed in a channel assembly covering at least four of the frequency sub-bands, by spread spectrum.

The present invention relates to a method and a system for transmitting information (that is to say point-to-point link) or for broadcasting (point-to-multipoint link) information in digital form from a satellite to terrestrial receivers limiting the reciprocal interference with a terrestrial radiocommunication system (designated by the term “Earth system” in the telecommunications regulations) occupying a frequency band exhibiting an overlap with that of the satellite. The general term “terrestrial receivers” will designate fixed or mobile receivers situated on the surface of the earth or in proximity to the latter.

The invention finds a particularly important, although nonexclusive, application in the sharing of radio resources between the downlinks of a satellite, in particular of a television satellite, and terrestrial systems such as digital television or radio broadcasting networks, RF systems, networks for communicating with mobiles, for example in accordance with the GSM or UMTS standard.

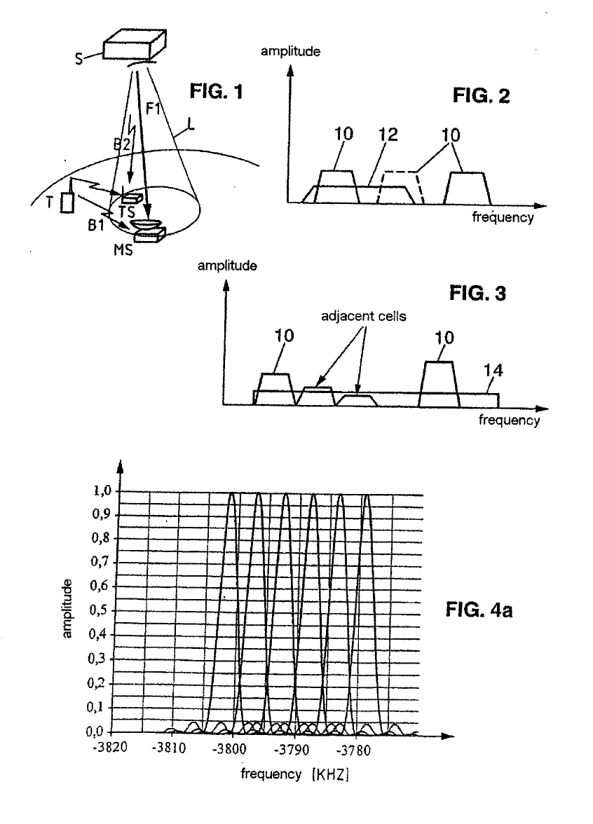

FIG. 1 diagrammatically shows various links that may give rise to mutual interference should they coexist in the same frequency band:

a downlink F1 from a satellite S to a receiving station MS exhibiting an omidirectional antenna, which will be the case for example for a station MS located on a vehicle such as a ship, and

an Earth network (terrestrial network).

The terrestrial network may comprise a base station T and stations or terminals TS. In many systems, the base station is not only a transmitting station. It talks to the receiving stations or terminals TS. Certain of the stations T and TS may be in the transmission lobe L of the satellite S and certain of the stations MS in a zone of exchanges between stations T and TS.

This coexistence leads to the station MS receiving not only useful power originating from the satellite S (arrow F1), but also interference power B1 originating from the stations of the terrestrial network. The stations of the terrestrial network that are located in the transmission lobe of the satellite receive, for their part, interference power B2.

The invention finds application whenever the terrestrial network is organized in such a way that the exchanges in adjacent zones are effected in different spectral sub-bands of specific width, that will be described as narrow.

In the particular case of terrestrial television systems, the radio resource allocated, for example in the UHF channels between 470 and 860 MHz, is distributed according to a frequency plan between the zones of coverage of the various transmitters and receivers. To do this, the allocated band is split up between channels or sub-bands, having center frequencies spaced 8 MHz apart. A similar distribution is effected in the case of telephony, except that the links are then bidirectional and occupy two channels, each allocated to one direction of communication.

To avoid mutual interference between the satellite link and the terrestrial system, the obvious solution consists in assigning them disjoint frequency bands, for example 4 GHz for the downlinks of a satellite, 620-790 MHz for terrestrial television and 900 or 1800 MHz for mobile telephony. This solution is increasingly unsatisfactory because it reduces the manageability of the available frequency spectrum.

It has also been proposed that the interference to terrestrial systems caused by satellite links be reduced by reducing the surface power density received on the surface of the earth from a satellite. However, the power received by the satellite terminals MS is thereby also reduced, so forcing the use of directional antennas. Another solution, usable in the case of fixed stations MS, consists in assigning the links from the satellite a frequency band outside of the band assigned to the terrestrial systems in the zone where the station MS is situated.

The present invention aims to solve the problem of interference while permitting an overlapping of frequency spans, in particular by achieving a new application of the already available spread spectrum techniques, including by direct sequence or by frequency hopping. More precisely, the invention starts from the finding that these techniques, by adapting them, make it possible to spread the power of the signal transmitted by the satellite over a very wide spectral band, amply greater than that of each of the terrestrial links, by profiting, in the case of many terrestrial networks, and in particular in the case of GSM and television, from the use of different, narrow sub-bands in adjacent zones and possibly the presence of guard bands.

With sufficient spreading as compared with the sub-bands, the interference caused by the terrestrial system in the reception by the satellite terminal MS can be much reduced, without it being necessary however, to employ a return pathway providing information allowing spread spectrum adaptation, as a function of the interference power received in each of the bands of the terrestrial system.

A consequence is to allow satellite downlinks access to the bands of the terrestrial systems. Another consequence is to allow, through a simple adaptation, the use, for satellite links, of waveforms and in particular of spreading techniques that are already widely used in the terrestrial domain.

The invention consequently proposes a method of transmitting or broadcasting information in digital form from a satellite to terrestrial receivers in the presence of a terrestrial network effecting links each occupying a specific and narrow frequency sub-band of an extended band, the sub-bands being assigned to different terrestrial zones within which the links are effected, according to which:

the information is put into the form of digital symbols,

the digital symbols are distributed over several carriers belonging to a group of carriers that are distributed within the whole of a channel covering at least four of said frequency sub-bands, employing spread spectrum.

It is advantageous to use carriers that are all disjoint and/or to perform a change of assignment of carriers over time. It is also advantageous to distribute the spread frequencies of one and the same program over the totality of one of the bands assigned to the terrestrial communications in the region where the transmission or broadcast from the satellite is effected.

The invention also proposes a system for transmitting or broadcasting information programs in digital form on the downlink from a satellite to one or more terrestrial receivers, comprising:

means for putting the information into the form of digital symbols, and

means for distributing the digital symbols of each program over several carriers belonging to the set of a group of carriers that are distributed in the totality of a band assigned by a radio resource planning process of the terrestrial network for communication in disjoint sub-bands in a set of terrestrial zones exhibiting an overlap with the lobe of the satellite, covering at least four of said frequency sub-bands, employing spread spectrum.

It may in particular involve an assignment by a regulating authority. The spreading of one and the same program may limit them, as indicated hereinabove, to only some of the sub-bands, adjoining or otherwise. However, advantageously, it is achieved over at least the totality of one of the bands assigned to terrestrial communications in the region where the transmission or broadcast from the satellite is effected.

It should be noted in passing that spread spectrum has been used hitherto as a defense against a specific type of interference, and not to reduce the effect of interference of a transmission.

It should also be noted that the invention achieves an application of the OFDM waveform which goes beyond the scope within which it has been proposed hitherto and which is to ensure time- and frequency-diversity using the variable characteristics of the propagation channel as regards attenuation and multipaths to improve transmission. The invention profits from the fact that the interferers taken into consideration are themselves subject to the variations of the propagation channel.

According to another aspect of the invention, there is proposed a transmitter carried by a satellite or transmitting from the earth to a satellite having a transparent payload for broadcasting to earth, making it possible to implement the method defined hereinabove and comprising:

means for putting the information into the form of digital symbols, and

means for distributing the digital symbols of each program over several carriers belonging to the set of a group of carriers that are distributed in at least four sub-bands of a band assigned by a radio resource planning process for communication in disjoint sub-bands in a set of terrestrial zones exhibiting an overlap with the lobe of the satellite, employing spread spectrum.

Finally, the invention also pertains to a terrestrial reception terminal comprising means for performing the operations dual to those of the above-defined method of transmission or broadcasting.

The above characteristics as well as others will become better apparent on reading the description which follows of particular embodiments, given by way of non-limiting examples. The description makes reference to the accompanying drawings, in which:

FIG. 1, already mentioned, is a diagram intended to depict the reciprocal interference between terrestrial and satellite networks;

FIG. 2 shows the spectral superposition causing the interference;

FIG. 3 shows an example of spread spectrum in the satellite S-terrestrial station MS link, as well as an appropriate width of spreading band compared with the bands allocated to the various terrestrial links;

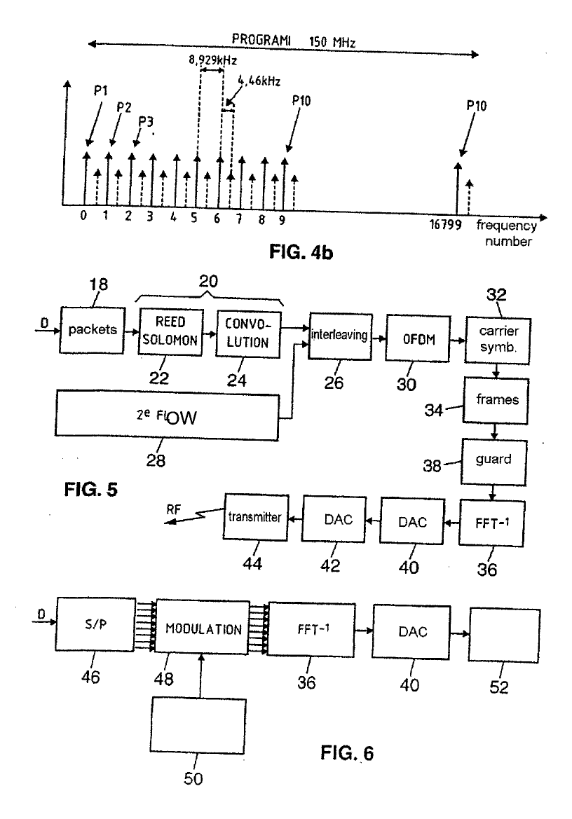

FIGS. 4a and 4b show respectively an example of spectral occupancy of the first carriers available for a so-called OFDM (Orthogonal Frequency Division Multiplex) multicarrier modulation, usable for spread spectrum should the invention be applied to a satellite broadcast in a band also allocated to terrestrial television, and a frequency interleaving;

FIG. 5 is a simplified schematic of a satellite transmitter and of a terrestrial station receiver allowing the implementation of the invention;

FIG. 6 is a schematic diagram showing a possible implementation of the method according to the invention on transmission;

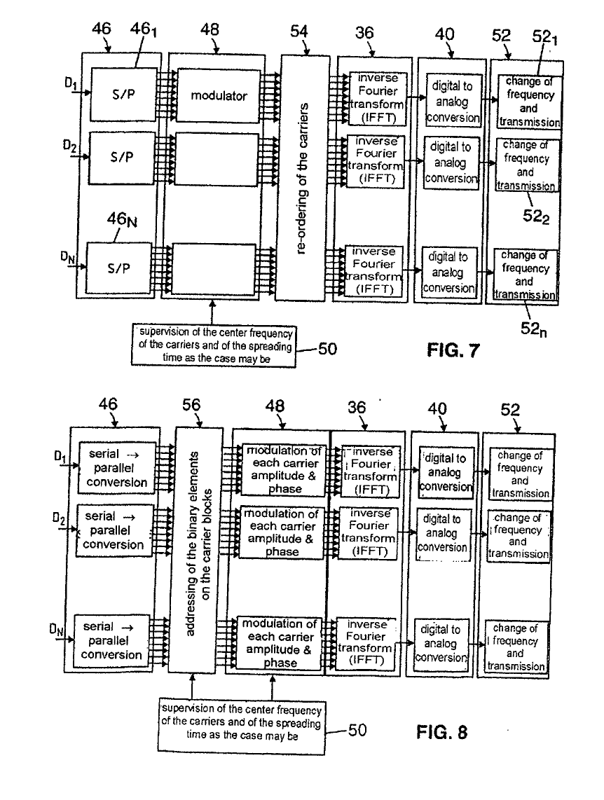

FIG. 7 is a variant implementation of the modulator, in the case of the simultaneous broadcasting of several programs;

FIG. 8 similar to FIG. 7, shows another possible layout of the modulator;

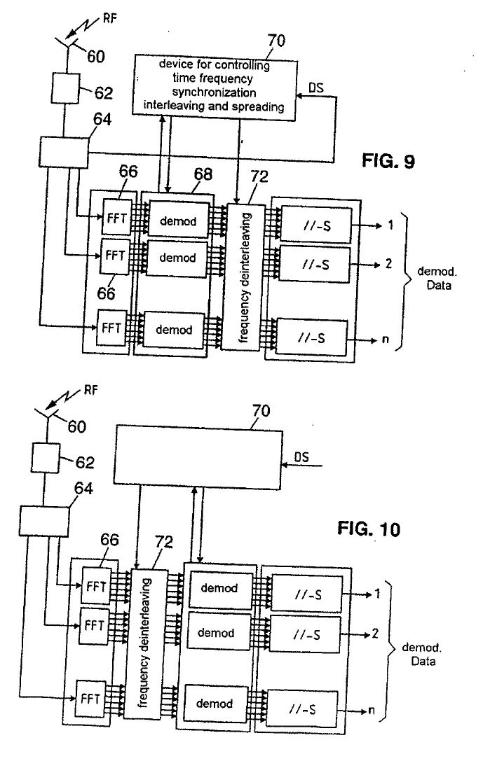

FIGS. 9 and 10 are partial schematics of receivers;

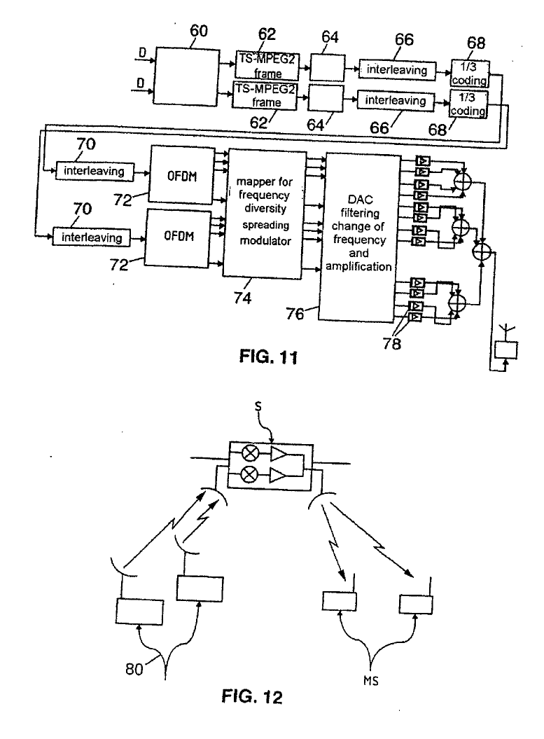

FIG. 11 is a schematic showing an exemplary implementation using low bit rate (a few bkps) MSK or GMSK modulators; and

FIG. 12 is a diagram showing broadcasting with a satellite having a transparent payload.

Before describing particular embodiments of the invention, it may be useful to depict the types of interference that the invention is aimed at reducing. FIG. 2 shows frequency sub-bands 10 in which the exchanges of a terrestrial network are performed, and in particular the transmission sub-bands of terrestrial station T in the lobe of the downlink of a satellite S. A frequency band of this link, in general of lower energy per unit area at the terrestrial level, is indicated at 12. The transmissions originating from the station T in the receiving band of the terrestrial station MS of the satellite link lead to interference. When the interference power, added to other disturbances (thermal noise of the receiver, environment) reaches a value such that the ratio of the useful power to the interference power drops below a specific threshold, the downlink of the satellite is no longer usable.

The same reasoning applies as regards the interference caused to the terrestrial links by the downlink of the satellite.

The interference may be particularly intense in the cells of a cellular telecommunication system if sub-bands which correspond to the frequency of the downlink of a satellite are used.

The principle implemented by the invention for reducing the customary interference is illustrated in FIG. 3. It consists spreading the frequency spectrum of the downlink of the satellite in such a way as to distribute the power over a much wider frequency band 14 than each of the frequency sub-bands each allocated to a terrestrial station T. Thus the interference caused by a terrestrial station T to a receiving station MS is appreciably decreased. In practice, in order to address the problem of the disturbing of a satellite downlink by a GSM type terrestrial cellular network and vice versa, it will suffice to carry out a frequency spreading on the downlink corresponding to at least four GSM sub-bands, and in practice this will lead to interference that is reduced and in one or two of the sub-bands only.

The spreading of the spectrum can be performed by direct sequence or by frequency hopping. The application of these techniques to satellite downlinks, which are typically wideband, for example from 6 to 8 MHz, in the case of a digital television signal, is tricky. Specifically, spreading by frequency hopping or by direct sequence can be used with acceptable complexity of the systems only for spreading bands of from 1 to 4 Mcps (megachips per second). A digital television signal on a downlink would have to undergo a spreading over a band of at least 80 Mhz, this rendering the customary existing apparatus inapplicable.

An advantageous solution for carrying out frequency spreading is the implementation of so-called OFDM or COFDM (Coded Orthogonal Frequency Division Multiplex) waveforms which correspond to a time/frequency transformation with distribution of the information over a large number of mutually orthogonal carriers. This type of waveform is advantageously associated with time division multiplexing, which makes it possible to take account of the temporal variations of the propagation channel, by virtue of blockwise interleaving of the bits to be transmitted. The risk of a large number of directly adjacent binary elements disappearing is thus avoided.

FIG. 4a shows just some of the first few carriers available for such OFDM modulation. Each symbol to be transmitted can be distributed over 1705 elementary carriers, having a separation of 4.4 kilohertz. The parameters may for example be the following:

duration of an OFDM elementary period: (7/64 microseconds)

number of elementary periods per OFDM symbol: 2048

useful duration of an OFDM symbol: 224 microseconds

spectral occupancy of an OFDM symbol: 76 12 Khz

modulation timing: 3.57 Khz.

The modulation with a view to transmission will generally be a four-state phase modulation, otherwise known as quadrature phase shift keying (QPSK). However, other types of modulation, for example eight-state phase modulation or QAM16 may be used. It will be seen moreover, that continuous phase modulation, in particular so-called MSK and GMSK modulations, exhibit advantages as regards the performance required of the power amplifiers of the satellite.

It may be useful at this juncture to recall the successive processing operations that are involved on transmission in a representative case of the use of the OFDM waveform.

As indicated in FIG. 5, a television program to be transmitted is shaped at 18 into the form of packets, of 188 bytes for example, in the MPEG-2, MPEG-4 or DVB ASI format, and is then subjected to coding at 20.

This coding is in two concatenated steps:

Reed-Solomon blockwise coding at 22, with a rate 188/204;

convolution coding at 24, for example of rate ½.

A temporal interleaving 26 is then performed, possibly while merging with another flow 28; a blockwise time division multiplexing is thus constructed which distributes the effects of the variations of the propagation channel over time.

The OFDM or COFDM modulation 30 is then performed and handles the frequency division multiplexing. It handles a frequency interleaving and appends analysis or pilot carrier symbols at 32. These additional symbols allow the synchronization of the receivers.

Each carrier of the signal is then subjected to a differential phase modulation 34 which gives rise to complex symbols. Guard intervals of duration Tg are introduced at 38. A frequency/time conversion 36 (inverse FFT generally) makes it possible to pass to the time domain. Finally, a digital/analog conversion precedes the change of frequency 42 and the transmission 44.

The customary OFDM signal is organized as superframes of four frames of 68 OFDM symbols, each of 1705 elementary carriers. Each symbol has a duration Ts=Tu+Tg (Tu being the duration of the useful part).

Several modes of usable frequency spreading will now be described by way of example.

The numerical examples that will be provided apply in particular in the case of potential interference to a downlink due to the transmission and the broadcasting of television programs on terrestrial networks, which occupy 8 MHz per channel. In this case, it will for example be possible to spread over:

170 MHz for a satellite link in the 620-790 MHz band

392 MHz for a satellite link in the 470-862 MHz band

Spreading by Direct Sequence

Each elementary carrier used for the downlink of a satellite is subjected to a direct sequence spreading, with a spacing between carriers that is sufficient to avoid overlapping thereof (avoiding as a consequence the use of two adjacent carriers of FIG. 4). The power spectral density, and hence the interference to the terrestrial channels, is thus decreased.

This method makes it possible moreover to reduce the possibility of reception by unauthorized third parties. Specifically, the initialization of a pseudo-random spreading sequence may necessitate an encryption key, possession of which conditions the plaintext recovery of the data transmitted.

The spreading may be performed in two ways in particular:

1) by increasing the modulation timing by multiplication by a direct sequence before OFDM modulation, the OFDM carriers then having a modified spacing.

2) by multiplying the in-phase pathway (I) and the quadrature pathway (Q) by specific pseudo-random sequences so as to perform the spreading before modulation.

In the first case, each carrier can be spread with a sequence which is either specific to it, or is the same for all the carriers of one and the same program (or of all the programs), thereby simplifying the implementation. However, it is preferable to choose different sequences for the I and Q pathways so as to avoid interference between these two pathways during demodulation.

The maximum frequency-wise spreading factor achievable depends not only on the width of the total band W used by the satellite, but also on the number P of programs to be transmitted. Specifically, the band of width B on which the spreading may be performed must fulfil the condition B=<W/P.

For example for the transmission of four programs in a band W=150 Mhz, the band occupied by a program will be a maximum of 37.5 Mhz, this representing a spreading E=37.5/8=4.69 i.e. about 5 contiguous channels of a terrestrial television network.

Spreading by Frequency Interleaving of the Programs

This mode of spreading is of the kind used in the DAB standard for example, but with the aim of increasing immunity to interference and not of reducing the effect of interference on other transmissions. This procedure is the one which reduces the power transmitted by the satellite most, by decreasing the transmitted power spectral density.

In this case, the spreading is performed by choosing, for a program, from among all the frequencies available, P frequencies (corresponding to the P discrete carriers of the program). The selection will generally be made in a pseudo-random manner. The various elementary carriers of each of the various programs are chosen to be orthogonal, that is to say the respective spectra of the various carriers do not overlap as in the standard OFDM mode.

For a total band W, there exist M solutions if each carrier occupies a band b, with M=W/b. The diversity factor thus obtained allows local avoidance of simultaneous interference to all the symbols.

The two examples below correspond to available bands 620-790 Mhz (case 1) and 470-860 Mhz (case 2), each with a bandwidth of 4.46 Khz for each unitary carrier.

| Parameter | Case #1 | Case #2 |
|---|---|---|
| Total band width available (KHz) | 170 | 390 |
| Possible number of carriers in the | 38080 | 87360 |
| band available | | |
| Number of carriers per program | 1705 | 1705 |
| Diversity factor for a program | 22.3 | 51.2 |

FIG. 4b gives an exemplary frequency plan of elementary carriers, with regular interleaving, in the case of ten interleaved programs.

Frequency Interleaving Varying Over Time

The interleaving scheme may either be fixed or random. In the first case, envisaged above, each program is assigned a batch of 1705 specific frequencies. A particular solution consists in distributing the carrier frequencies used by a particular program in a regular manner. However, to give equal processing to all the programs, it is possible to exchange frequencies between programs by pseudo-randomly picking frequencies allocated to each program from a global batch of frequencies. Thus the assigning of the bits to carriers as a function of their position in bit train is continuously modified over time. A temporal interleaving is thus appended. A further advantage of such an assignment with respect to an invariable assignment is that one thereby eliminates the risk of seeing bits corresponding to particularly important parameters (intra coding bits in MPEG television for example) transmitted continuously on frequencies subjected to interference from narrowband interferers.

Spreading by Frequency Hopping

This method supplements the frequency interleaving with the possibility of modifying the interleaving over time, by changing over time the frequencies of each of the unitary carriers, this involving agility of modification of frequency of the local oscillators used.

Combination of Procedures

The above procedures may be combined in particular to allow the transmission from the satellite S of a high power with a given maximum power spectral density.

Possible Layouts of Transmitter and Receiver

Possible layouts of a transmitter (and in particular of the modulator) and of a receiver allowing implementation of the invention will now be given.

FIG. 6 is a basic diagram of the steps implemented on transmission in a particular embodiment.

The data D fed to the modulator have already been formatted, for example in accordance with the diagram of FIG. 5. The nature of this formatting may be very diverse, for example hierarchical multiplexing, MPEG-2 framing, blockwise coding, convolutional coding, temporal interleaving, frequency interleaving, etc. The processed data are applied to a serial/parallel converter 46 which distributes the various binary elements over the various carriers which will make up the OFDM waveform. The actual modulator 48 modulates each of the carriers in phase and possibly in amplitude as a function of the binary elements of the data and of the chosen type of modulation (PSK2, PSK4, PASK8, PASK16, etc.). The calculation of the phase and possibly of the amplitude is performed by a supervisory facility 50, consisting of a processor, which determines a time distribution and provides the modulation and direct sequence spreading parameters in the case where this procedure is used.

That part of the modulator situated downstream of the element 48 is conventional. It comprises an element 36 performing an inverse Fourier transform and a digital/analog converter 40. This converter may also perform a filtering. Finally, the box 52 indicates a block which groups together the components performing the change of frequency, amplification, wideband filtering and transmission.

In the case where n programs are transmitted simultaneously, the layout of the modulator may be that shown diagrammatically in FIG. 7, where the elements corresponding to those already described are designated by the same reference numeral, subscripted when the component is particular to a program. In this case, there are as many serial/parallel converters 46₁, . . . , 46n as programs. Again, there are also as many actual modulators, inverse Fourier transformers, digital converters and frequency changing and transmission modules as there are programs. One and the same processor 50 may be used to supervise the center frequency of all the carriers and handle the spreadings.

Each serial/parallel converter 46₁, . . . , 46n has practically the same layout as in the previous case, since the input data of each program are processed separately.

The modulator of FIG. 7 comprises a device inserted ahead of the inverse Fourier transformation processors for re-ordering the carriers, so that each transformer processes only a subset of carriers which are contiguous and not disjoint. The presence of this device implies that the various programs to be transmitted are dealt with globally.

In the variant embodiment shown in FIG. 8, in which the blocks 46, 48, 36, 40 and 52 are not detailed, a device 56 is inserted so as to perform an interleaving that takes all the programs into account globally, before modulation. This provision makes it possible for just subsets of baseband contiguous carriers to be processed by the inverse Fourier transformation processors 36. The load on the processors carrying out this transformation function is thereby reduced. It then becomes necessary to assign a different frequency changing function to the frequency changing module 52 for each block constituting this device, whereas this was not the case for blocks 52₁, . . . 52ₙ, of FIG. 7. The device 50 must moreover control the interleaving of the various symbols of the various programs on various carriers, according to a distribution scheme that may be fixed over time or that may vary over time.

The receiver can have the general layout shown in FIG. 9. The essential part of the demodulators consists of the means for handling global deinterleaving taking all the programs into account. The global structure of the demodulator is practically independent of the embodiment of the transmitter and accommodates all the variants mentioned above. Specifically, the demodulator works over the whole of the wide spreading band and therefore must operate independently of the interleaving schemes.

In FIG. 9, the RF radio frequency signal originating from the satellite is converted into an electrical signal by the antenna 60. A module 62 handles amplification, filtering and frequency conversion to a lower frequency. The module 64 performs an analog/digital conversion and a conversion to baseband. Moreover, it duplicates- the signal so as to supply several fast Fourier transformation processors 66. The use of several processors rather than just one is aimed at reducing the processing capacities demanded of each of the processors. The number of them is independent of the number of programs.

A block 68 handles the demodulation. This block comprises several elementary demodulators, so as to limit their processing capacity. In order to operate, the demodulators must receive phase information and amplitude information as well as supervisory instructions. A module 70 handles the timewise and frequency-wise synchronization of the demodulators and provides them with the direct spreading sequences, as the case may be. The frequency deinterleaving block 72 handles the rearranging of the information according to the programs by using a deinterleaving sequence which is either fixed and stored once and for all, or varied over time, in which case it is provided by the device 70. This device itself receives signaling data DS originating from the transmitter and defining the interleaving path, the temporal distribution, the spreading sequences used, etc. These signaling data may be extracted by the block 64. The signaling data DS may, in particular, be transmitted on the pilot frequencies and the synchronization channels that are generally envisaged in the customary types of OFDM modulation.

The demodulators 68 can also provide information about the state of the channel, the signal-to-noise ratio and the frequencies most affected by interference, so as to send, on a return pathway, indications allowing the frequencies to be modified.

In the variant embodiment shown in FIG. 10, the frequency deinterleaving block 72 is placed ahead of the demodulators, thereby making it possible to integrate, into the demodulators, the functions of channel equalization and decoding before restitution of the binary information. In FIG. 10, the elements corresponding to those of FIG. 9 bear the same reference numeral.

The detailed layout of the various blocks and modules incorporated into the transmitter and the receiver will not be described here since it can be one of those currently used for other applications. The characteristics of PSK, MSK and GMSK modulations and the customary OFDM and COFDM forms are given in various documents to which one may refer, for example:

ETSI EN 300 744 V1.4.1 (2001-01) European standard—Digital Video Broadcasting (DVB)

Performance of COFDM for satellite digital audio broadcasting, A. Franchi et al. Int. On Satellite communication., vol. 13, 229-242, 1992.

PSK modulations, and in particular the frequently used QPSK modulation, lead to an amplitude that varies very strongly on input to an amplifier, this possibly making it necessary to employ clipping devices and to operate the amplifiers far from saturation. This drawback may be greatly reduced by using continuous phase modulation and in particular minimum phase gradient modulation, termed MSK, possibly gaussian, termed GMSK. The frequency of the carrier is then advantageously an integer multiple of a factor 4 of the modulation timing. Thus, it is possible to have an input signal with substantially constant amplitude on input to the amplifiers of the satellite and to operate them in proximity to saturation. One may be content to reduce the ratio of the peak amplitude to the mean amplitude by using so-called 2-PSK2 or OQPSK modulation.

In FIG. 11, which gives an exemplary implementation, the elements corresponding to those of the previous figures are again designated by the same numeral.

The data and the signaling D to be transmitted for each program may be subjected to a hierarchization at 60, for example by separately processing the two flows represented so as to further protect the sensitive data (intra-coding in digital television). FIG. 11 then shows the placing into MPEG2 frames at 62, the blockwise coding 64, the temporal interleaving 66, the convolutional coding 68 and the frequency interleaving 70 on each flow. The distributing of frequencies by shaping into OFDM form is then carried out globally by mapping processors 72. The frequency diversity and the spreading over the entire span allocated are handled by a block comprising a mapping memory and a group of low bit rate (typically a few kbps) MSK or GMSK modulators 74. It is not possible to use an inverse Fourier transform since this would destroy the phase continuity of the MSK or GMSK signals, whereas the demodulation may be performed conventionally with a fast Fourier transform.

It is then possible to perform a first change of frequency in digital form so as to distribute the carriers, this easing the implementation of interference diversity. A second, fixed, conversion may occur, if necessary, and after conversion at 76. Each carrier is amplified by a solid-state amplifier 78 of low power (of the order of 1 W) operating in saturated mode (therefore having very good efficiency). Each amplifier amplifies only a very small part of the information (typically 0.01%). The MSK waveform supports this mode of amplification well and moreover the out-of-band transmissions are limited. Finally, the signals are juxtaposed and transmitted by the antenna.

This procedure is applicable with embedded demodulation and OFDM remodulation, or else with digital processing of signals without demodulation of the carriers (the frequency conversion can be carried out at the time of digital processing).

In the embodiment of the system for broadcasting to mobiles from terrestrial stations 80 which is shown in FIG. 12, the payload of the satellite S is transparent.

The terrestrial stations 80 transmit the programs on the uplink M after formatting (and synchronization of the spreading frequencies if necessary) to the satellite S. The latter converts the signal received and transmits it back to the ground toward the various terminals MS located within its coverage. In this case, all the operations defined in the method according to the invention are performed on the ground.

In a first variant, each of the stations TS transmits the signal in the form of a single carrier (for example with the DVB-S format or with the DVB-T standard). On receipt of the uplink, the payload of the satellite demodulates and decodes the signals received, and reformats them according to the method. The transmission stations 80 are then independent of the method.

Another variant is applicable to the case of the use of the DVB-T standard on transmission. Given that the method is independent of the DVB-T waveform, the variants not employing direct spread spectrum may be implemented without demodulating the carriers but merely with reorganization of the carriers as a function of the laws programmed on board the satellite. These laws may be chosen on command of a ground-based supervisory station for example.

1. A method of transmitting or broadcasting information in digital form from a satellite to terrestrial receivers in the presence of a terrestrial network effecting links each occupying a specific and narrow frequency sub-band of an extended band, the sub-bands being assigned to different terrestrial zones within which the links are effected, according to which:
the information is put into the form of digital symbols,
the digital symbols are distributed over several carriers belonging to a group of carriers that are distributed within the whole of a channel covering at least four of said frequency sub-bands, employing spread spectrum.

2. The method as claimed in claim 1, for broadcasting a television program, characterized in that the channel exhibits a width of:
170 MHz for a satellite link in the 620-790 MHz band
392 MHz for a satellite link in the 470-862 MHz band.

3. The method as claimed in claim 1, characterized in that the spread frequencies of one and the same program are distributed over at least the totality of one of the bands assigned to the terrestrial communications in the region where the transmission or broadcast from the satellite is effected.

4. The method as claimed in claim 1, 2 or 3, characterized in that the spread spectrum is effected by implementing an OFDM or COFDM waveform shaping.

5. The method as claimed in claim 1, 2 or 3, characterized in that the spreading of each elementary carrier is performed by direct sequence, with a spacing between carriers that is sufficient to avoid their overlapping.

6. The method as claimed in claim 5, characterized in that the spreading of each carrier is performed by multiplication by a common sequence, possibly with identification of the sequence on receipt by knowledge of an encryption key.

7. The method as claimed in claim 5, characterized in that the spreading of each carrier is performed by multiplying the I and Q pathways by different sequences.

8. The method as claimed in claim 1, 2 or 3, characterized in that the spreading is performed by a frequency interleaving.

9. The method as claimed in claim 1 for the simultaneous broadcasting of several programs, according to which the modulation step comprises as many serial/parallel conversions (46₁, . . . , 46n), separate modulations, inverse Fourier transformations, digital/analog conversions and change of frequency and transmission as there are programs, the center frequency of all the carriers and the spreadings being handled by a common processor (50).

10. A system for transmitting or broadcasting information programs in digital form on the downlink from a satellite to one or more terrestrial receivers, comprising:
means for putting the information into the form of digital symbols, and
means for distributing the digital symbols of each program over several carriers belonging to the set of a group of carriers that are distributed in at least four sub-bands of a band assigned by a radio resource planning process for communication in disjoint sub-bands in a set of terrestrial zones exhibiting an overlap with the lobe of the satellite, employing spread spectrum.

11. The system as claimed in claim 10, in which the group of carriers consists of carriers distributed in at least the totality of the assigned band.

12. The system as claimed in claim 10 or 11, according to which said means belong to the payload of the satellite and said satellite receives the programs through an uplink on a single carrier.

13. The system as claimed in claim 10 or 11, according to which said means are incorporated into a terrestrial station for transmitting on an uplink to the satellite and the payload of said satellite is transparent.

14. A transmitter carried by a satellite or transmitting from the earth to a satellite having a transparent payload for broadcasting to earth, making it possible to implement the method as claimed in claim 1, comprising:
means for putting the information into the form of digital symbols, and
means for distributing the digital symbols of each program over several carriers belonging to the set of a group of carriers that are distributed in at least four sub-bands of a band assigned by a radio resource planning process for communication in disjoint sub-bands in a set of terrestrial zones exhibiting an overlap with the lobe of the satellite, employing spread spectrum.

15. A reception terminal comprising means for performing the operations dual to those of the method as claimed in claim 1.
